(19) United States
(12) Patent Application Publication
(10) Pub. No.: US 2009/0197553 A1
(43) Pub. Date: Aug. 6, 2009

(54) Method and Apparatus for Determining Frequency Offset in a Receiver

(75) Inventor: John Sidney Stewart, Indianapolis, IN (US)

Correspondence Address: Thomson Licensing LLC, P.O. Box 5312, Two Independence Way, PRINCETON, NJ, 08543-5312, US

(73) Assignee: THOMSON LICENSING, Boulogne-Billancourt (FR)

(21) Appl. No.: 12/085,418

(22) PCT Filed: Dec. 1, 2005
(86) PCT No.: PCT/US2005/043472

§ 371 Date: May 21, 2008

(51) Int. Cl. H04B 1/16

(52) U.S. Cl. 455/207

(57) ABSTRACT

The disclosed embodiments relate to a method and apparatus for determining the frequency offset in a receiver. The apparatus includes a link circuit. The link circuit includes a frequency translator for translating the input signal, a detector for measuring the magnitude of the translated signal, and a controller for determining a maximum value of magnitude of a plurality of magnitudes measured by the detector as a result of controlling the frequency translator. The method includes receiving an input signal, mixing the signal with a plurality of frequencies, processing the plurality of second signals to generate a plurality of magnitudes and a plurality of associated frequency values, and determining a maximum magnitude from the plurality of magnitudes.

### FIELD OF THE INVENTION

The present invention relates generally toward a communications receiver. More specifically, the present invention relates to determining a frequency offset that may be present in a received signal at the receiver.

### BACKGROUND OF THE INVENTION

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

As most people are aware, satellite television systems have become much more widespread over the past few years. In fact, since the introduction of digital satellite television in 1994, more than twelve million American homes have become satellite TV subscribers. Most of these subscribers live in single-family homes where satellite dishes are relatively easy to install and connect. For example, the satellite dish may be installed on the roof of the house. In order to continue this growth, the customer often expects more every year from the service. The service providers thus are constantly considering new features and upgrades such as recording, multi-room operation, and larger and better content. Recently, more attention has become focused on high definition video and audio signals.

High definition signals require more capacity or bandwidth than the services currently provided on the satellite system. Also many high definition services are provided in addition to, rather than as a replacement to, the current service. In order to provide these new services, some service providers are increasing the total capacity of their systems. Capacity can be increased in a number of ways including increasing the number of transponders or satellite channels available or increasing the number of satellites used. The largest change to the satellite system involves changing the actual communications system specifications.

Recent advances in technology have allowed satellite system service providers to consider increasing capacity by changing the system specifications in a number of ways including using a new decoding algorithm such as one created by the Motion Picture Entertainment Group (MPEG) commonly known as MPEG-4. Additionally, it is possible to utilize a more advanced modulation format such as eight level phase shift keying (8PSK) found in the standard created for digital video broadcast (DVB), known as DVB-S2. The DVB-S2 standard also provides for a new error correction system known as low density parity check (LDPC) coding, which allows a further increase in overall system capacity. Although these changes can increase capacity in the communications system, they may also change the operating margins for receiving the signal and force changes in the receiver design.

In order to satisfy increasing customer expectations, it remains important that these advances do not interrupt the currently expected operation of the service. One parameter the user may consider important, even with the new and advance services, is the amount of time it takes to acquire and change program channels. Channel change time may be significantly affected by the changes (i.e., lowering the signal to noise ratio (SNR) of the incoming signal and/or increasing the complexity of modulation format and decoding function) made to the communications system. One important element of the channel acquisition time involves determining and correcting for frequency offset. Frequency offset is the offset that exists between the expected received frequency and the actual received frequency.

Receiving systems, such as those employed in satellite receivers, normally contend with frequency offsets that are caused by system components such as low noise block converters (LNBs), the tuner in the satellite receiver, and clock reference errors. The offset may remain static or they may change with time or as a result of temperature changes. A major portion of the channel acquisition time is spent in determining the frequency offset of the received signal and then providing a means for correcting it so that proper signal demodulation can occur.

One current solution to the problem of determining and correcting frequency offset in a receiver involves using a control loop, such as a digital carrier tracking loop in a digital demodulator. The control loop is adjusted as to allow the loop to determine and in some cases correct the frequency offset that may be present. However, the performance of the carrier tracking loop is dependant upon the signal quality received, as well as the type of signal being operated on. Current systems used for products such as satellite receivers operate in an environment where the SNR is above 3 dB and the modulation format is quadrature phase shift keying (QPSK). The frequency offset that must be recovered is usually specified to be +/−5 Megahertz (MHz). Under these conditions, the traditional phase locked loop (PLL) used as a carrier recovery loop cannot locate and lock to a signal over the full +/−5 MHz possible frequency offset. The loop in this case would step or tune through several ranges of pull-in in order to cover full range of frequency offset. If the pull-in range for the PLL is +/−1 MHz, then in order to recover a frequency offset of +/−5 MHz, the PLL is forcibly re-tuned in steps of approximately 2 MHz such that some number of steps cover all of the required frequency search space. With currently available hardware, this procedure can be done relatively quickly since there are only approximately 5 steps needed to cover the entire range and the signal conditions allow the PLL to use a relative large pull-in range.

However, the newer satellite transmission specifications previously discussed (e.g., DVB-S2) have modes that operate at signal to noise ratios of 1 dB or less. Also, the DVB-S2 specifications contain modulation formats with more signal points than the traditional QPSK systems. For example, the DVB-S2 specification contains 8-PSK, as well as others. For modes that have very low SNR and/or higher constellation types, the pull-in range of traditional PLL carrier recovery systems must be reduced from the pull-in range of older systems in order for the loop to lock to a signal rather than the background noise. If the pull in range is not reduced then the loop may lock to background noise resulting in an undesirable no-lock or false lock condition. For example cases, the pull-in range needed to properly lock to a system using a newer satellite transmission spec may only be +/−50 KHz. With such a small pull-in range, a stepped approach to frequency recovery would require approximately 100 steps. The time to acquire a signal containing a large offset would be considerably increased and it is likely that the user would consider the increase in time unacceptable.

As a result a new method for determining frequency offset is desirable. Further it is desirable that the apparatus that determines the frequency offset include some ability to correct the frequency offset.

### SUMMARY OF THE INVENTION

The present invention is directed towards the determination of the frequency offset associated with various processing elements within a communications system. More specifically, the present invention relates to a system and method for determining a frequency offset under a variety of conditions including low Signal to Noise Ratio when employing various modulation schemes.

The apparatus of the present invention includes a frequency translator for translating the input signal to a plurality of second signals each having a different frequency. The apparatus further includes a detector for measuring the magnitudes of the plurality of second signals. The apparatus also includes a controller that can determine a maximum value of a plurality of magnitudes measured by the detector.

The method of the present invention includes receiving an input signal, mixing the signal with a plurality of frequencies to generate a plurality of second signals each having a different carrier frequency, and processing the plurality of second signals to generate a plurality of magnitudes and a plurality of frequency values associated with those magnitudes. Further, the method includes determining a maximum magnitude from the plurality of magnitudes.

### BRIEF DESCRIPTION OF THE DRAWINGS

Advantages of the invention may become apparent upon reading the following detailed description and upon reference to the drawings in which:

FIG. 1 is a block diagram of an exemplary link circuit for demodulating signals.

FIG. 2 is a block diagram of the link circuit of the present invention.

FIG. 3 is a flow chart illustrating a method for determining frequency offset of the present invention.

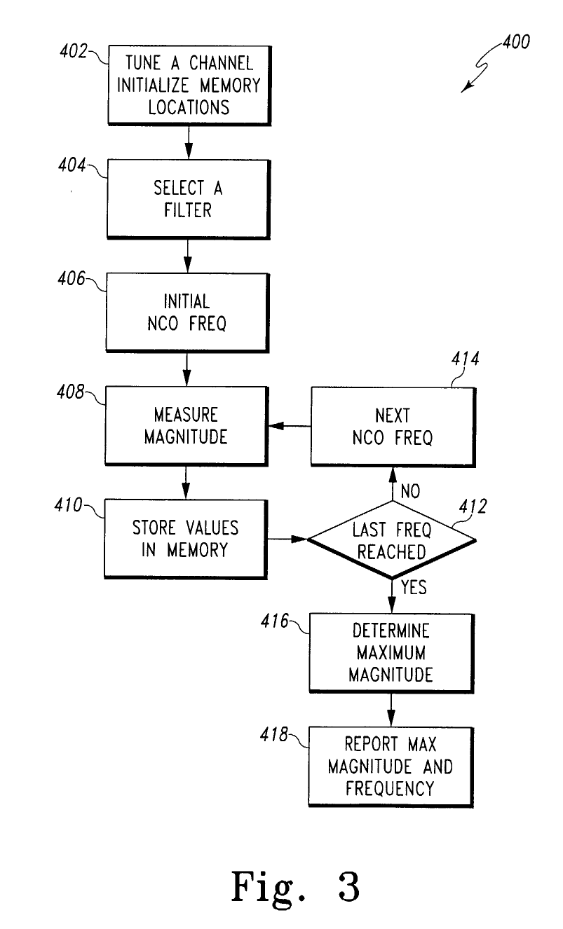

The characteristics and advantages of the present invention may become more apparent from the following description, given by way of example.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The following describes a circuit used for receiving satellite signals. Other systems utilized to receive other types of signals where the signal input may be supplied by some other means may include very similar structures. Those of ordinary skill in the art will appreciate that the embodiment of the circuits described herein is merely one potential embodiment. As such, in alternate embodiments, the components of the circuit may be rearranged or omitted, or additional components may be added. For example, with minor modifications, the circuits described may be configured to for use in non-satellite video and audio services such as those delivered from a cable network.

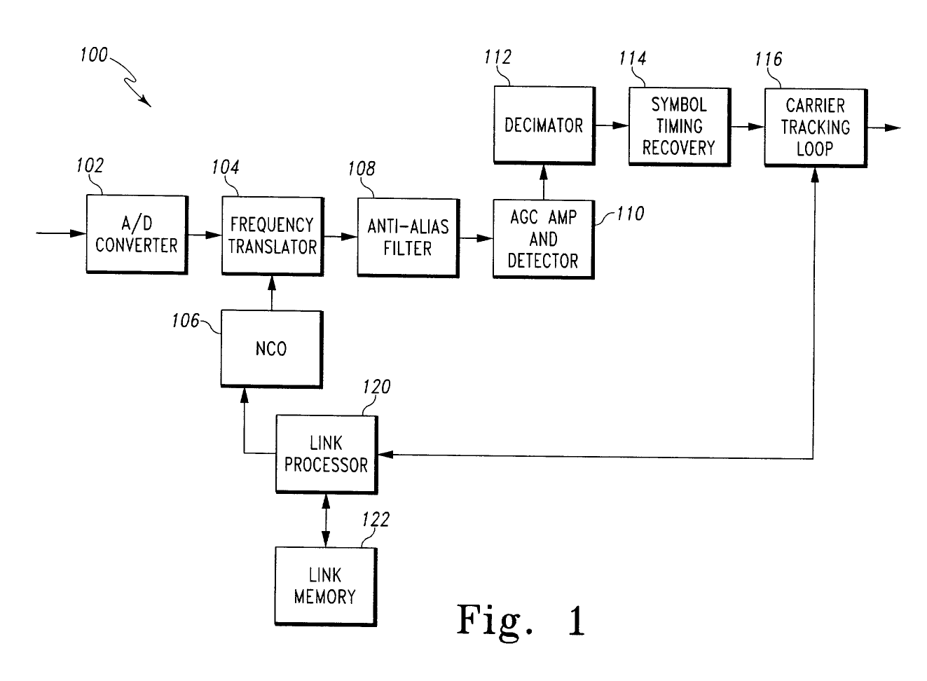

Turning now to FIG. 1, an exemplary link circuit 100 used for digital demodulation is shown. At the input to the circuit, an analog to digital (A/D) converter 102 is connected to a frequency translator 104. A numerically controller oscillator (NCO) 106 is also connected to the frequency translator 104. The output of the frequency translator 104 is connected to the anti-alias filter 108 and the anti-alias filter 108 is connected to the automatic gain control (AGC) amp block 110. The output of the AGC amp block 110 is connected to a decimator block 112 that is connected to the symbol timing recovery block 114. Finally the symbol timing recovery block 114 is connected to a carrier tracking loop 116. A link processor 120 is connected to, the NCO 106, the carrier tracking loop 116, and a link memory 122. For clarity, some connections and blocks may be omitted but one skilled in the art should recognize these omissions. The operation of each these blocks will be further described below.

The link circuit 100 contains an A/D converter 102 for converting the one or more baseband signals delivered from a tuner, not shown, to a digital signal. The digital signal from A/D converter 102 represents a series of samples of the one or more baseband signals, where each sample containing, for instance, a 10 bit word of data. A clock signal, not shown, is also connected to the A/D converter in order to produce the series of samples. The clock signal may be generated from a source such as a crystal.

The digital signal from the A/D converter 102 is then supplied to a frequency translator 104. The frequency translator 104 also receives an input signal supplied from the NCO 106. The NCO 106 and frequency translator 106 are capable of shifting the incoming digital signal with respect to the incoming signal's carrier frequency, thereby producing a frequency shifted digital signal. The NCO 106 is typically a programmable frequency digital signal source. Control for programming the digital frequency of the NCO 106 may be generated by the link processor 120. The frequency translator block 104 and NCO 106 allows a frequency offset, determined by the carrier tracking loop 116, to be removed directly in circuitry located in the link circuit 100. The output of the frequency translator 104 supplies the frequency shifted digital signal to the anti-alias filter 108. The anti-alias filter 108 is typically a digital filter that is used to remove signal energy not associated with the desired incoming signal while passing the desired incoming signal essentially unchanged.

The filtered digital signal passes into the automatic gain control (AGC) block 110. The AGC block 110 contains a gain controllable digital signal amplifier and a signal detector. The signal detector is used to measure the magnitude of the signal present in the AGC block 110. The detector in the AGC block 110 may typically detect the total power of the signal over a time period. The output of the detector in the AGC block 110 is typically connected in a loop as a control signal for the gain controllable digital signal amplifier in a way that the output of the amplifier may be maintained at a constant level.

The AGC block 110 outputs a gain compensated signal from its controllable digital signal amplifier and supplies the gain compensated signal to a decimator 112. The decimator 112 reduces the effective sampling rate by removing samples of the gain compensated signal based on a comparison of the incoming signal sampling rate and the required sample rate for the symbol timing recovery block 114.

The symbol timing recovery block 114 contains a control loop that adjusts the phase of the incoming decimated signal in order to optimize the sampling position and allow optimal detection of the symbols of data sent in the incoming signal. The output of the symbol timing recovery block 114 then connects to a block containing the carrier tracking loop 116. The carrier tracking loop contains a control loop that determines and corrects the phase and/or frequency of the incoming signal with respect to an expected or correct carrier frequency. The carrier tracking loop 116 typically performs the determining and correcting of carrier frequency without consideration for the actual values of the symbols.

The output of the carrier tracking loop 116, now a demodulated signal, is passed to downstream processing blocks such as an error correction block, not shown, for further processing.

In operation, the carrier tracking loop 116 determines the frequency offset of the incoming signal. The link processor 120 controls the operating parameters of the carrier tracking loop 116, such as the loop bandwidth, lock in range, and nominal frequency of lock in range, as known by those skilled in the art. The carrier tracking loop 116 outputs values to the link processor 120 such as lock condition and frequency offset the carrier tracking loop 116 has determined. The values may then be used to either further program the carrier tracking, for instance to step the nominal frequency of lock in range. The link processor 120 may also use the values to adjust the frequency programmed in the NCO 106. As described earlier, the time that the carrier tracking loop 116 takes to determine the frequency offset and lock to the incoming signal's carrier frequency for signals such as those used in newer satellite systems may be unacceptable.

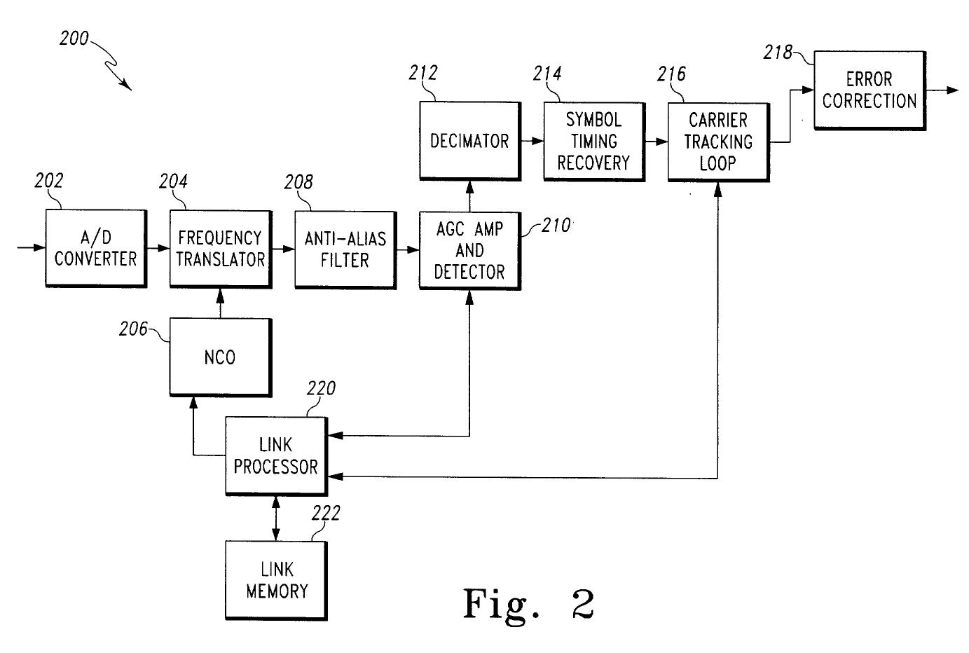

Turning now to FIG. 2, an exemplary link circuit 200 of the present invention is shown. At the input to the circuit, an A/D converter 202 is connected to a frequency translator 204. An oscillator, such as an NCO 206, is also connected to the frequency translator 204. The output of the frequency translator 204 is connected to the anti-alias filter 208 and the anti-alias filter 208 is connected to the AGC amp block 210. The output of the AGC amp block 210 is connected to a decimator block 212 that is connected to the symbol timing recovery block 214. The symbol timing recovery block 214 is connected to a carrier tracking loop 216 and finally the carrier tracking loop block 216 is connected to the error correction block 218. A link processor 220 is connected to the NCO 206, the AGC amp block 210, the carrier tracking loop 216, and a link memory 222. For clarity, some connections and blocks may be omitted but one skilled in the art should recognize these omissions. The operation of each these blocks will be further described below.

The link circuit 200 contains an A/D converter 202 for converting the one or more baseband signals delivered from a tuner, not shown, to a digital signal. The digital signal from A/D converter 202 represents a series of samples of the one or more baseband signals, where each sample contains, for instance, a 10 bit word of data. It is important to note that the preferred embodiment utilizes one or more baseband signals as the inputs to the A/D converter 202. However, in another embodiment the signal(s) provided by the tuner as inputs to the A/D converter 202 may be located at a frequency that is near baseband, or may be located at some other intermediate frequency (IF).

A clock signal, not shown, is also connected to the A/D converter in order to produce the series of samples. The clock signal may be generated from another source such as a crystal and/or also may be further controlled by link processor 220. In one embodiment, the link processor 220 may determine the clock rate that is necessary for proper processing of the incoming received signal. In another embodiment, the sampling in the A/D converter 202 may be done at a fixed rate and processing, such as decimating the sampled signal down to the proper sampling rate, may be done in later blocks.

The digital signal from the A/D converter 202 is then supplied to the frequency mixer or frequency translator 204. The frequency translator 204 also receives an input signal supplied from the NCO 206. The NCO 206 and frequency translator 204 are capable of shifting the incoming digital signal with respect to the incoming signal's carrier frequency, thereby producing a frequency shifted digital signal. The NCO 206 is typically a programmable frequency digital signal source. Control for programming the digital frequency of the NCO 206 may be generated by the link processor 220. In some embodiments, control may also be determined by the carrier tracking loop 216, described later, either in conjunction with the link processor 220 or separate from it. The operating range of the NCO 206 may be specified in terms of its frequency offset adjustment range. This range may be determined using a number of factors such as the incoming digital signal's symbol rate and/or the sampling rate the A/D converter 202 uses for processing -the incoming baseband signal. In one embodiment, the frequency translator block 204 and NCO 206 allows a frequency offset, determined by the carrier tracking loop 216 to be removed directly in circuitry located in the link circuit 200. Correcting the offset within the link circuit 200 eliminates the possible re-tuning of the tuner, which may result in additional time delay that is undesirable to the user.

The output of the frequency translator 204 supplies the frequency shifted digital signal to the anti-alias filter 208. The anti-alias filter 208 is typically a digital filter that is used to remove signal energy not associated with the desired incoming signal while passing the desired incoming signal essentially unchanged. Depending upon the range of symbol rates of the input signals possible for demodulating in the link circuit 200, the anti-alias filter 208 may be a set of one or more fixed filters or a programmable filter. In a preferred embodiment, anti-alias filter 208 may be programmed to change its passband frequency response and/or other characteristics. In another embodiment, the filter may be programmed to match a passband characteristic of the incoming frequency shifted digital signal. One such passband characteristic may be signal bandwidth.

The filtered digital signal passes into the AGC amp block 210. The AGC amp block 210 may contain a gain controllable digital signal amplifier and a signal detector. The detector in the AGC amp block 210 is used to measure the magnitude of the signal present. The detector may detect the total power of the signal, for instance as a root mean square (RMS) power, over a time period. The detector in the AGC block 210 may be connected in a loop as a control signal on the gain controllable digital signal amplifier, in a way that the output of the amplifier may be maintained at a constant level. In addition, the detector within the AGC block 210 may be used to provide an indication of the incoming signal level. One output of the detector, the level indicator signal, then may be routed to the link processor 220 for further processing.

The AGC block 210 outputs a gain compensated signal from its controllable digital signal amplifier and supplies the gain compensated signal to a decimator 212. The decimator 212 reduces the effective sampling rate by removing samples of the gain compensated signal based on a comparison of the incoming signal sampling rate and the required sample rate for the symbol timing recovery block 214.

The symbol timing recovery block 214 contains a control loop that adjusts the phase of the incoming decimated signal in order to optimize the sampling position and allow selected detection of the symbols of data sent in the incoming signal. The output of the symbol timing recovery block 214 is connected to the carrier tracking loop 216. The carrier tracking loop 216 contains a control loop that may determine and/or correct the phase and/or frequency of the incoming signal with respect to an expected or correct carrier frequency. The carrier tracking loop 216 may perform the determination and correction without consideration for the actual values of the symbols.

It is important to note that symbol timing recovery block 214 and carrier tracking loop 216 may be operatively coupled with respect to each other and/or with respect to other blocks in the link circuit 200, as is known to one skilled in the art. Additionally, the carrier tracking loop 216 described here typically contains the earlier specified limitations that become inherent based on the incoming signal properties with respect to frequency offset.

The output of the carrier tracking loop 216, now a de-rotated signal, enters the error correction block 218. Typically the error correction block 218 may contain a symbol slicer module for determining the actual symbol values. The error correction block 218 may also contain the symbol to bit mapper module used to generate the bits, containing data and error correction bits. Additionally, the error correction block 218 contains modules for utilizing the error correction information that has been sent along with the data in the incoming signal. A number of types of error correction methods may be employed in communications systems such as the systems described herein, as known to those skilled in the art. Some error correction methods may include Reed-Solomon error correction, trellis error correction, or interleaving. Also, some newer types known as turbo code error correction and LDPC error correction may also be used. Any of these error correction methods may be used individually or may be combined to work together, as is known by those skilled in the art.

Referring now to FIG. 4, a flow chart (400) encompassing the method of the invention is shown. The flow chart contains steps indicating a complete process based on a particular embodiment of the method. One skilled in the art should appreciate that several of the steps may be omitted or exchanged in order to accommodate a different embodiment. First, at step 402, the tuner is tuned to receive a channel (e.g. a satellite transponder) delivered from the L-band signals. Additionally at step 402, the link circuit 200 may be initialized under the control of the link processor 220. Included in this initialization may be any initializing of registers for use with the NCO 206, AGC block 210 and link memory 222. At step 404, the anti-alias filter 208 may be programmed to a bandwidth. If the anti-alias filter 208 does not allow for programming the filter bandwidth then step 404 may be omitted. The bandwidth may be selected based on several criteria including the bandwidth of the incoming channel, the signal quality and/or operating parameters of the incoming channel, or the range of possible bandwidths in the anti-alias filter 208. In one embodiment, the anti-alias filter 208 may be programmed to its narrowest possible value, for instance, 500 KHz. In another embodiment, the anti-alias filter 208 may be programmed to a value that is approximately one half of the bandwidth of the incoming channel.

At step 406, the NCO 206 is programmed to a first or starting frequency. This frequency may be chosen as a frequency at one end of the possible tuning range of the NCO 206. For example, the NCO 206 may be tuned initially for its lowest frequency. The tuning range of the NCO 206 is often chosen in order to cover a specific frequency range over which the incoming signal may be known to be present when considering frequency offset. In a preferred embodiment, the tuning range of the NCO 206 is chosen to span the range of frequencies equal to the Nyquist frequency of highest bandwidth signal to be received. In another embodiment, the NCO range may be chosen to span a range of frequencies equal to or greater than the total frequency offset that can occur in the system.

It will also be important that a pattern for tuning the NCO 206 be created and followed, because the process will need to step through a series of frequencies. For instance, in one embodiment, the tuning starts with the lowest frequency as the first frequency, and will end with the highest frequency as the last frequency, and step through a set of frequencies in between. In most cases, the pattern may be stored in a memory or derived as an algorithm in the link processor 220 prior to tuning the NCO 206.

After the NCO 206 is at its starting frequency, a measurement of the signal power is made, at step 408, using the AGC block 210. In one embodiment, the measurement may be made using the level indicator output from AGC block 210, described earlier, that is connected to the link controller. In one embodiment, the link controller may use the level indicator output directly as the measured value, while in other embodiments, the link controller may perform some additional processing such as averaging more than one sample at different time instances in order to derive the measured value.

The measured value from the link processor 220, at step 410, is stored in a specific location in memory such as in link memory 222. Additionally, the link processor 220 can store an indication of the frequency of the NCO 266 in a separate specific location in memory. The frequency value may be stored in any useful manner, for instance, it may stored as an absolute frequency value, as a scaled relative value, or as an offset value from the central value or desired value. The value that is stored may be used later and the information needed may be recovered, based on knowledge of the format of the stored value.

Step 412 initiates a repeat branch. If at step 412, the last frequency value for the NCO 206 has not yet been reached, then the process continues to step 414, where the NCO 206 is changed to the next step value of tuning frequency. In a preferred embodiment, the step value may be incremented from its previous value. The value of the increment value may depend on a number of factors. For instance, the increment may be the value of bandwidth chosen for use in the anti-alias filter 208. In any case the size of the increment value and the total range of frequency for the NCO 206 will determine the number of times the repeat branch returns. The repeat branch goes back to step 408, to measure the power in AGC block 210 based on the new tuning frequency in the NCO 206. The process then continues to step 410 as before to record both this new measured power and the new step value of frequency in the memory. Finally the process returns to step 412 to determine if the last frequency value for the NCO 206 has been reached.

If at step 412, the last frequency value has been reached in the NCO 206 (for instance, the highest frequency value of the tuning range of the NCO 206) then the repeat process ends and the decision branch at step 412 now continues to step 416. At step 416, the process for determining the largest measured value commences. The largest value for measured power may be determined by the link processor 220 retrieving and processing the previously stored values in the link memory 222. The link processor may either directly compare value by value or may apply a “windowing” function on sets of consecutive values. In the windowing function, a contiguous set of data from memory is processed to produce a windowed value. In one embodiment, the window is selected to correspond to the bandwidth of the incoming signal, and the number of data points used in the window is the multiple between the signal bandwidth and the bandwidth chosen earlier for the anti-alias filter 208. The choice of the window function may be done based on a number of parameters and may be selected in a manner to assure proper signal detection by attempting to assure that the signal will appear within the window function. For example, if the signal bandwidth is 10 MHz and the anti-alias filter bandwidth chosen is 1 MHz, then the “window” may be 10 MHz and the number of data points taken for each window may be 10. In order to facilitate the window near the first value and the last value stored, either the window function may begin at a point where the function is filled, the endpoints values may be repeated to fill the window, or the function can include a division step that accounts for the reduced window size near the endpoints of the memory. The same windowing function may then also be applied to the frequency values that are associated with each of the magnitude values that were stored in the link memory 222. After the windowed values have been created, then these windowed values are compared to determine the largest windowed value.

Last, at Step 418, the largest measured individual value or largest measured windowed value is reported, and in addition the value of frequency corresponding to the largest measured individual value or largest measured windowed value is also reported. These values can then be used in further adjustment of other blocks in the link circuit 200. In one embodiment, the reported value of frequency corresponding to the largest measured value may be processed by the link controller 218 to generate a new value used for programming the nominal frequency of operation of the NCO 206. In another embodiment, the value of frequency corresponding to the largest measured value can be processed by link processor 220 to produce a loop frequency offset value, used for programming the carrier tracking loop 216. In yet another embodiment, the link processor 220 can use the value of frequency corresponding to the largest measured value along with the largest measured value to determine how much adjustment to apply to either the NCO 206 or carrier tracking loop 216. Once the process described here is complete, the link circuit 200 may begin processing the incoming signal under its usual operation.

In another embodiment requiring a minimum amount of memory in the link memory 220, step 416 may be eliminated and step 410 may be modified to store only the largest value of magnitude measured to that point, and the associated frequency. In this embodiment, as each loop including steps 408, 410, 412, and 414, is executed the latest value of measured magnitude is compared to the currently stored maximum value. If the latest value of magnitude is larger than the currently stored value, the currently stored value and the associated frequency value are replaced with the latest value of magnitude and associated frequency. Otherwise the memory locations are left unmodified until the next value of magnitude is determined. Once the loop is completed at decision branch in step 412, the values in memory are the values for reporting in step 418.

Using the method and apparatus described, the amount of time spent determining frequency offset during channel acquisition may be significantly reduced. The frequency offset may typically be determined within a relatively small error, such as +/−1 MHz, even with a signal with a very low SNR such as at 1 dB SNR. Using this method, would allow a carrier tracking loop 216 to operate with the narrow range of pull-in necessary for low SNR signals, and not require the carrier tracking loop 216 to step through a large number of pull-in ranges. This method also works equally well with any modulation format.

Additionally this method can serve as a sort of “coarse tuning” of frequency offset allowing more accurate fine tuning to remain within another block such as the carrier recovery loop 216 as described earlier. For instance, the described invention may be used to reduce the frequency search space as much as possible to shorten the time required to acquire the signal. The invention may be used to reduce the acquisition search space during the fine tuning phase to around +/−1 MHz or less. Then at this amount, traditional acquisition approaches such as those described earlier may be used to complete the acquisition of the signal in this reduced search space due to removal of some portion of the frequency offset.

Additionally, the invention illustrated here is not limited to processes involving initial tuning of a communications system. The process described in the invention may also be utilized at any time such as a check that the system has found the correct frequency offset previously, or in the event that the frequency offset may have changed in the system and must now be determined and corrected.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A method comprising the steps of:
receiving a signal having a first carrier frequency;
mixing said received signal with a signal having a plurality of frequencies to produce a plurality of second signals, each second signal having a different carrier frequency;
processing said plurality of second signals to generate a plurality of magnitudes and a plurality of frequency values associated with said plurality of magnitudes; and
determining a maximum magnitude from said plurality of magnitudes.

2. The method set forth in claim 1, further comprising the step of identifying a selected frequency value wherein said selected frequency value is the value of frequency associated with said maximum magnitude.

3. The method set forth in claim 2, further comprising the step of using said selected frequency value to correct a frequency offset.

4. The method set forth in claim 1, further comprising the step of storing said plurality of magnitudes and said plurality of frequency values associated with said plurality of magnitudes in a memory in an order in which said plurality of magnitudes and said plurality of frequency values are generated.

5. The method set forth in claim 1, wherein the step of processing further comprises filtering said plurality of second signals to improve resolution of said magnitude values.

6. The method set forth in claim 5, wherein said filtered second signals have a bandwidth that is not equal to a bandwidth of said second signal.

7. The method set forth in claim 1, wherein the step of processing further comprises measuring the magnitude of said plurality of filtered second signals.

8. The method set forth in claim 7, wherein the step of measuring the magnitude further comprises determining the root mean square power of said filtered second signal.

9. The method set forth in claim 1, wherein the step of mixing further comprises mixing said received signal with a plurality of discrete frequencies stepping from a starting frequency to an ending frequency.

10. The method set forth in claim 9 wherein said starting frequency is lower than said stopping frequency.

11. The method set forth in claim 1, wherein the step of determining further comprises:
storing said plurality of said magnitudes and said plurality of frequency values;
windowing said stored plurality of said magnitudes and said stored plurality of said frequency values to generate a plurality of windowed magnitudes and a plurality of windowed frequency values; and
determining a maximum windowed magnitude from said plurality of windowed magnitudes.

12. The method set forth in claim 11, further comprising the step of identifying a selected windowed frequency value wherein said selected windowed frequency value is the value of windowed frequency associated with said maximum windowed magnitude.

13. The method set forth in claim 12, further comprising the step of using said selected windowed frequency value to correct a frequency offset.

14. An apparatus comprising:
a frequency translator for translating a first signal having a first carrier frequency to a plurality of second signals each having a different carrier frequency:
a detector coupled to said frequency translator for measuring a plurality of magnitudes of said plurality of second signals; and
a processor coupled to said frequency translator and said detector whereby said processor determines a maximum magnitude from a plurality of magnitudes measured by said detector.

15. The apparatus set forth in claim 14, whereby said processor further determines a selected frequency value wherein said selected frequency value is the value of frequency associated with said maximum magnitude.

16. The apparatus set forth in claim 15 whereby said processor further uses said selected frequency value to correct a frequency offset.

17. The apparatus set forth in claim 15 further comprising a memory for storing said plurality of magnitudes and said plurality of frequency values associated with said plurality of magnitudes in a memory in an order in which said plurality of magnitudes and said plurality of frequency values are generated.

18. The apparatus set forth in claim 14 further comprising a filter coupled between said frequency translator and said detector for filtering said plurality of second signals to improve resolution of said magnitude values from said detector.

19. The apparatus set forth in claim 18 wherein said filter has a bandwidth that is different than bandwidth of said signal having a second carrier frequency.

20. The apparatus set forth in claim 14 whereby said processor further stores said plurality of magnitudes, windows said stored plurality of said magnitudes, generates a plurality of windowed magnitudes and a plurality of windowed frequency values, and determines a maximum windowed magnitude from said plurality of windowed magnitudes.

21. The apparatus set forth in claim 20 whereby said processor further determines a selected windowed frequency value associated with said maximum windowed magnitude.

22. The apparatus set forth in claim 14 wherein said frequency translator comprises a mixer and an oscillator.

23. The apparatus set forth in claim 22 wherein said oscillator is a numerically controlled oscillator

24. The apparatus set forth in claim 14 whereby said processor determines a maximum magnitude from a plurality of magnitudes measured by said detector as a result of iteratively controlling said frequency translator.

25. The apparatus set forth in claim 14 whereby each of said plurality of second signals is generated at a different time.

26. An apparatus comprising:
a means for receiving a signal having a first carrier frequency;
a means for mixing said received signal with a signal having a plurality of frequencies to produce a plurality of second signals, each second signal having a different carrier frequency;
a means for processing said plurality of second signals to generate a plurality of magnitudes and a plurality of frequency values associated with said plurality of magnitudes; and
a means for determining a maximum magnitude from said plurality of magnitudes.
